(19) United States
(12) Patent Application Publication
(10) Pub. No.: US 2012/0140783 A1
(43) Pub. Date: Jun. 7, 2012

(54) Wavelength-Tunable Laser Source Apparatus

(75) Inventor: Chien-Hung Yeh, Hsinchu City (TW)

(73) Assignee: Industrial Technology Research Institute, Chutung (TW)

(21) Appl. No.: 13/046,077

(22) Filed: Mar. 11, 2011

(30) Foreign Application Priority Data
Dec. 6, 2010 (TW) 99142309

(51) Int. Cl. H01S 3/10

(52) U.S. Cl. 372/20

(57) ABSTRACT

A wavelength-tunable laser source apparatus is provided, having first and second Fabry-Perot laser diodes, a tunable bandpass filter and an optical coupler. One of the first and second Fabry-Perot laser diodes outputs a light source to be injected into the other of the first and second Fabry-Perot laser diodes. The tunable bandpass filter is coupled between the first and second Fabry-Perot laser diodes to adjust the light source to a desired wavelength mode. The optical coupler couples the light source, wherein a gain resonance cavity is formed by the first and second Fabry-Perot laser diodes, the tunable bandpass filter and the optical coupler, and the optical coupler outputs light in the gain resonance cavity to serve as a laser source.

### CROSS REFERENCE TO RELATED APPLICATIONS

This Application claims priority of Taiwan Patent Application No. 099142309, filed on Dec. 6, 2010, the entirety of which is incorporated by reference herein.

### BACKGROUND OF THE INVENTION

1. Field of the Invention

The present invention relates to a wavelength-tunable laser source apparatus, and in particular relates to a wavelength-tunable laser source apparatus having Fabry-Perot laser diodes.

2. Description of the Related Art

As optical transmission techniques develop, optical transmission techniques have been applied more widely since optical fiber transmission has transmission rate/transmission distance benefits and anti-interference capabilities. In general, the light sources of optical fiber communication are Fabry-Perot laser diodes, wherein the Fabry-Perot laser diodes, using the Fabry-Perot interference principle, generate light. However, the light sources from fast wavelength-tunable systems using the Fabry-Perot laser diodes have a low side mode suppression ration. Therefore, there is a need for an apparatus and a system with a high side mode suppression ration and steady power to serve as light sources of optical fiber communications.

### BRIEF SUMMARY OF THE INVENTION

In light of the previously described problems, the invention provides an embodiment of a wavelength-tunable laser source apparatus, comprising first and second Fabry-Perot laser diodes, a tunable bandpass filter and an optical coupler. One of the first and second Fabry-Perot laser diodes outputs a light source to be injected into the other of the first and second Fabry-Perot laser diodes. The tunable bandpass filter is coupled between the first and second Fabry-Perot laser diodes to adjust the light source to a desired wavelength mode. The optical coupler couples the light source, wherein a gain resonance cavity is formed by the first and second Fabry-Perot laser diodes, the tunable bandpass filter and the optical coupler, and the optical coupler outputs light in the gain resonance cavity to serve as a laser source.

The invention also provides an embodiment of a laser system, comprising a wavelength-tunable laser source array, an optical switcher and a controller. The wavelength-tunable laser source array comprises a plurality of wavelength-tunable laser source apparatuses to output a plurality of laser sources, wherein the laser sources have different central wavelengths. Each of the wavelength-tunable laser source apparatus comprises first and second Fabry-Perot laser diodes, a tunable bandpass filter and an optical coupler. One of the first and second Fabry-Perot laser diodes outputs a light source to be injected into the other of the first and second Fabry-Perot laser diodes. The tunable bandpass filter is coupled between the first and second Fabry-Perot laser diodes to adjust the light source to a desired wavelength mode. The optical coupler couples the light source, wherein a gain resonance cavity is formed by the first and second Fabry-Perot laser diodes, the tunable bandpass filter and the optical coupler, and the optical coupler outputs light in the gain resonance cavity to serve as a laser source. The optical switcher is coupled to the wavelength-tunable laser source array to receive the laser source thereby selectively outputting one of the laser sources. The controller is coupled to the wavelength-tunable laser array to control a wavelength mode of the laser sources.

The invention also provides a method for adjusting a laser source wavelength. The method comprises the steps of injecting light from a first Fabry-Perot laser diode into a second Fabry-Perot laser diode by an optical coupler and a tunable bandpass filter; injecting light from the second Fabry-Perot laser diode into the first Fabry-Perot laser diode by the optical coupler and the tunable bandpass filter such that a gain resonance cavity is formed with the first and second Fabry-Perot laser diodes, the tunable bandpass filter and the optical coupler; and outputting light in the gain resonance cavity to serve as a laser source.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts an embodiment of the wavelength-tunable laser source apparatus having Fabry-Perot laser diodes of the disclosure.

FIG. 2a is a schematic view showing an embodiment of multiple output modes of the Fabry-Perot laser diode 12 of the disclosure.

FIG. 2b is a schematic view showing an embodiment of multiple output modes of the Fabry-Perot laser diode 13 of the disclosure.

FIG. 3 is a schematic view showing an embodiment of the gain resonance cavity of the disclosure.

FIG. 4 depicts a waveform of a laser source output by the wavelength-tunable laser source apparatus of the disclosure.

FIG. 5 shows the relationship between wavelength, power and side mode suppression ration of the wavelength-tunable laser source apparatus.

FIG. 6 depicts an embodiment of the laser system of the disclosure.

FIG. 7 is a sequence diagram of the method for adjusting a laser source wavelength.

FIG. 8 shows the relationship between wavelength, power and timing of the wavelength-tunable laser source apparatus.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present disclosure provides a wavelength-tunable laser source of an optical fiber communication. Embodiments of the disclosure use Fabry-Perot laser diodes with multiple output modes to serve as inter-injection light sources and reflecting elements of a gain resonance cavity thereby forming a wavelength-tunable laser source structure with high side mode suppression ration and high power stability.

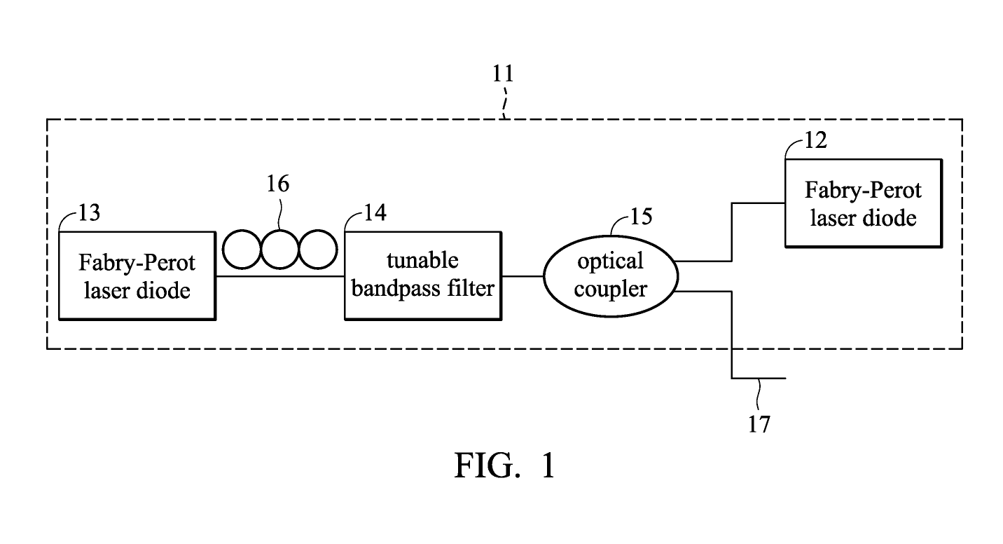

FIG. 1 depicts an embodiment of the wavelength-tunable laser source apparatus having Fabry-Perot laser diodes of the disclosure. As shown in FIG. 1, the wavelength-tunable laser source apparatus 11 includes Fabry-Perot laser diodes 12 and 13, a tunable bandpass filter 14 and an optical coupler 15. For example, one of Fabry-Perot laser diodes 12 and 13 outputs a light source to the other, respectively. In detail, a Fabry-Perot laser diode 12 outputs a light source to a Fabry-Perot laser diode 13, and a Fabry-Perot laser diode 13 outputs a light source to a Fabry-Perot laser diode 12. The tunable bandpass filter 14 is coupled between the Fabry-Perot laser diodes 12 and 13 to adjust the light source to a desired wavelength mode. The optical coupler 15 couples the light source. In this embodiment, the light sources reflect back and forth among the Fabry-Perot laser diodes 12 and 13, the tunable bandpass filter 14 and the optical coupler 15. Thus, a gain resonance cavity is formed with the Fabry-Perot laser diodes 12 and 13, the tunable bandpass filter 14 and the optical coupler 15, and the optical coupler 15 outputs light in the gain resonance cavity to serve as a laser source 17. In this embodiment, the optical coupler 15 can be a 1×2 and 50:50 optical coupler. In some embodiments, the optical coupler 15 can be another type of optical coupler, for example, a 2×2 optical coupler or a 4×2 optical coupler, but it is not limited thereto. The gain resonance cavity of the disclosure uses an inter-injection light source; therefore, the gain resonance cavity is an inter-injection resonance cavity.

In some embodiments, the wavelength-tunable laser source apparatus 11 further includes a polarization controller 16. The polarization controller 16 has a first terminal coupled to the output of the Fabry-Perot laser diode 13 and a second terminal coupled to the input of the optical coupler 15 to control the polarization state of light from the Fabry-Perot laser diodes 12 and 13. The polarization controller 16 maintains light from the Fabry-Perot laser diodes 12 and 13 at a steady state when the Fabry-Perot laser diode 12 is deposited far from the Fabry-Perot laser diode 13.

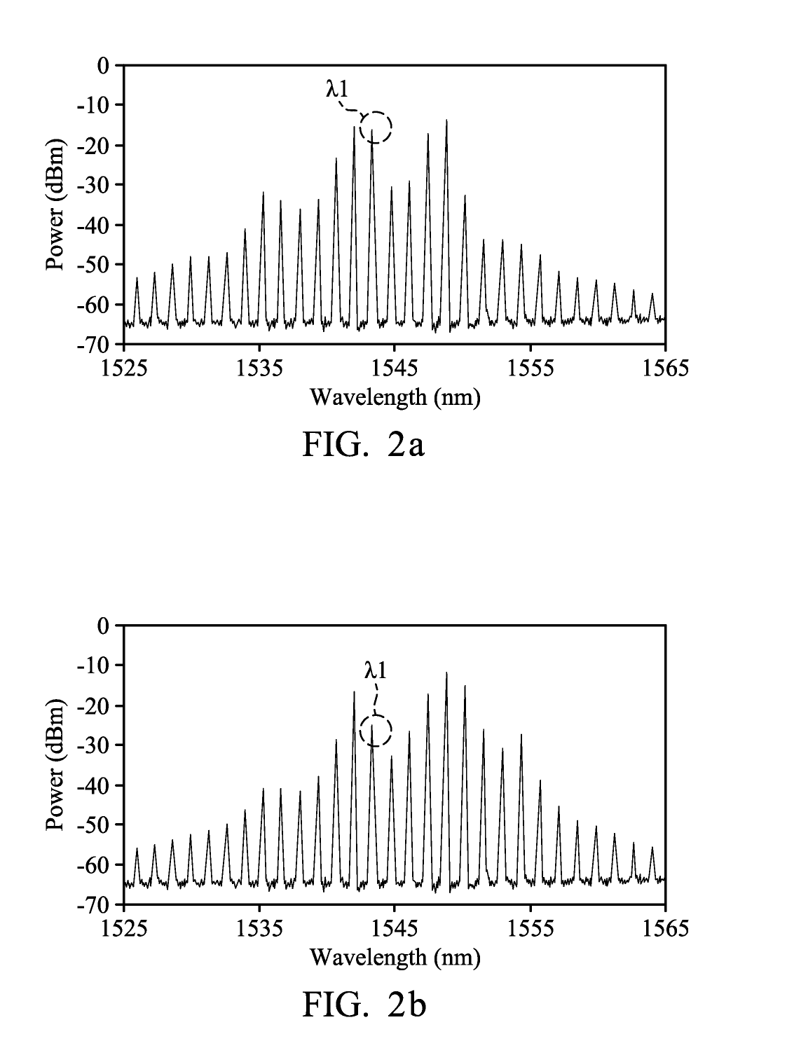

FIG. 2a is a schematic view showing an embodiment of multiple output modes of the Fabry-Perot laser diode 12 of the disclosure. FIG. 2b is a schematic view showing an embodiment of multiple output modes of the Fabry-Perot laser diode 13 of the disclosure. As shown in FIG. 2a and FIG. 2b, the Fabry-Perot laser diodes 12 and 13 both have multiple output modes and a central wavelength of the Fabry-Perot laser diode 12 is the same as a central wavelength of the Fabry-Perot laser diode 13 (e.g., the Fabry-Perot laser diodes 12 and 13 match each other). Each two output mode has a fixed mode spacing. In some embodiments, the central wavelength of the Fabry-Perot laser diode 12 is different from the central wavelength of the Fabry-Perot laser diode 13, but certain output modes of the Fabry-Perot laser diode 12 are required to be the same as certain output modes of the Fabry-Perot laser diode 13.

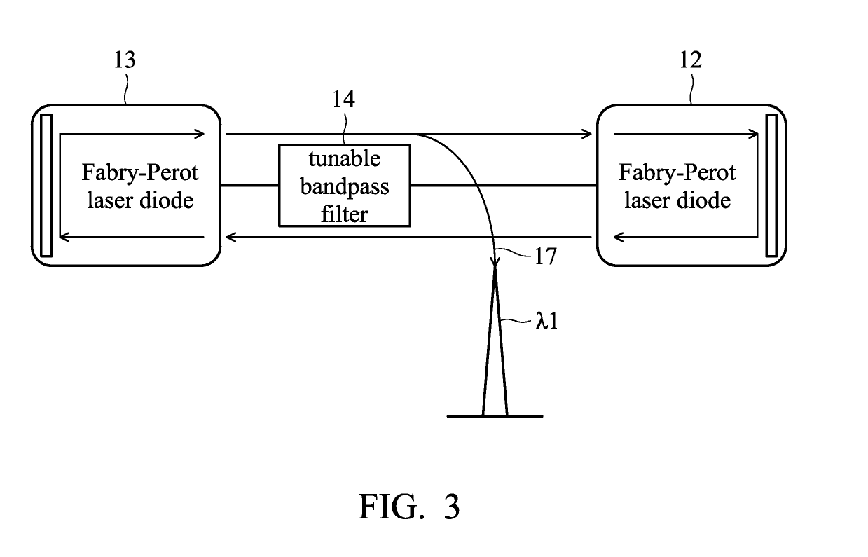

FIG. 3 is a schematic view showing an embodiment of the gain resonance cavity of the disclosure. As shown in FIG. 3, the gain resonance cavity is formed with the Fabry-Perot laser diodes 12 and 13, the tunable bandpass filter 14 and the optical coupler 15 (not shown in FIG. 3). The tunable bandpass filter 14 selects one of the output modes of the Fabry-Perot laser diodes 12 and 13 (i.e., wavelength λ 1) to serve as the wavelength mode of the laser source 17. In some embodiments, the reflectivity of the front surfaces of the Fabry-Perot laser diodes 12 and 13 is about 35˜45% and the reflectivity of the back surfaces of the Fabry-Perot laser diodes 12 and 13 is about 99%, but it is not limited thereto. In the gain resonance cavity, light is reflected by the back surfaces of the Fabry-Perot laser diodes 12 and 13 and the selected output mode is enhanced by the gain mediums of the Fabry-Perot laser diodes 12 and 13 to increase the side mode suppression ration.

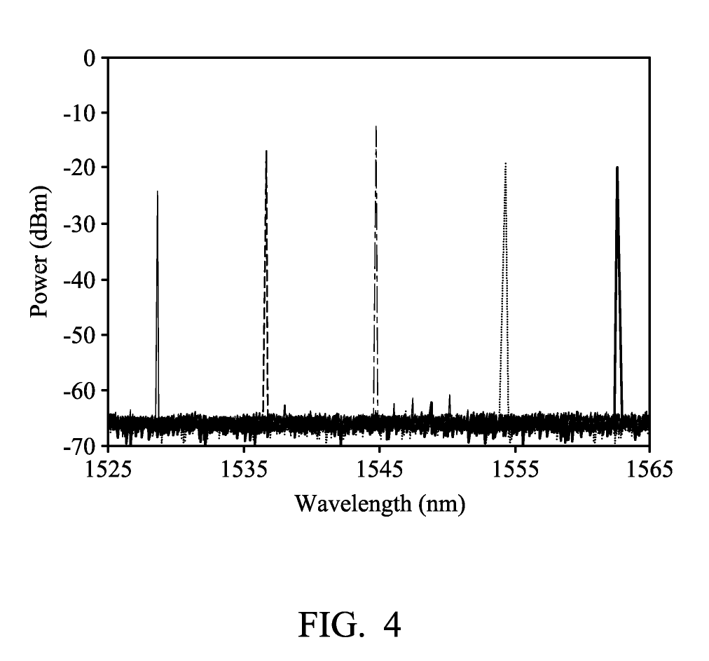

FIG. 4 depicts a waveform of a laser source output by the wavelength-tunable laser source apparatus of the disclosure. The wavelength mode of the laser source of the disclosure can be tuned according to user requirements. The tuning step of the wavelength mode of the laser source 17 is determined by the fixed mode spacing of the Fabry-Perot laser diodes 12 and 13 (i.e., the fixed mode spacing is 1.4 nm, but it is not limited thereto). In detail, as shown in FIG. 2a and FIG. 2b, the Fabry-Perot laser diodes 12 and 13 have a plurality of output modes. One of the output modes is allowed to pass through the tunable bandpass filter 14, but the other output modes are not allowed to pass through the tunable bandpass filter 14. Therefore, the tuning step tuned by the tunable bandpass filter 14 is the fixed mode spacing. As shown in FIG. 4, the range of the wavelength modes of the laser source 17 is tunable from 1528.6 nm to 1562.6 nm, but it is not limited thereto. FIG. 4 only depicts five wavelength modes of the laser source 17 for illustration, but in fact, the laser source 17 has more than five wavelength modes.

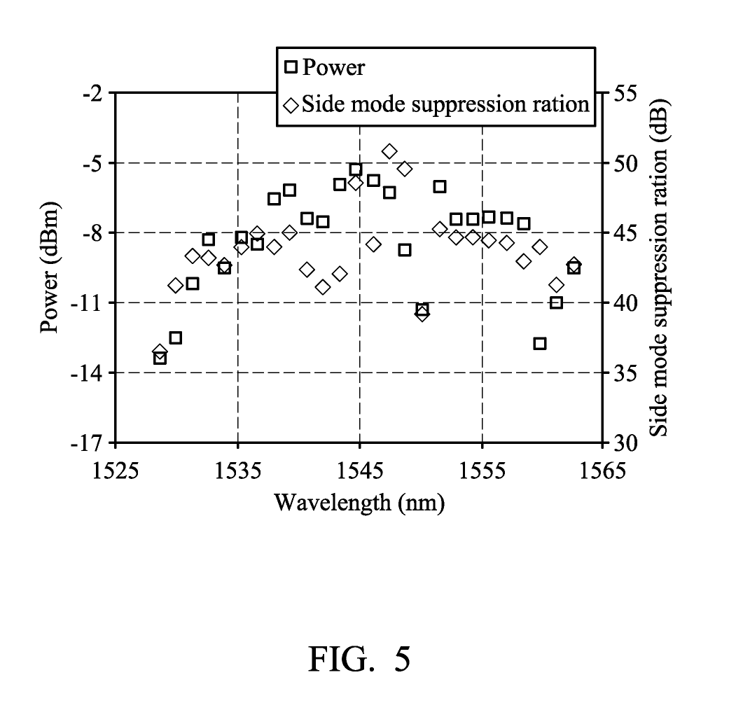

FIG. 5 shows the relationship between wavelength, power and side mode suppression ration of the wavelength-tunable laser source apparatus. As shown in FIG. 5, the higher side mode suppression ration is accompanied by the higher power, and the lower side mode suppression ration is accompanied by the lower power. In other words, the side mode suppression ration is proportional to the power. As shown in FIG. 5, the power and the side mode suppression ration of the wavelength modes far from the central wavelength of the Fabry-Perot laser diodes 12 and 13 are lower such that the range of the wavelength modes with better side mode suppression ration is from 1535 nm to 1555 nm.

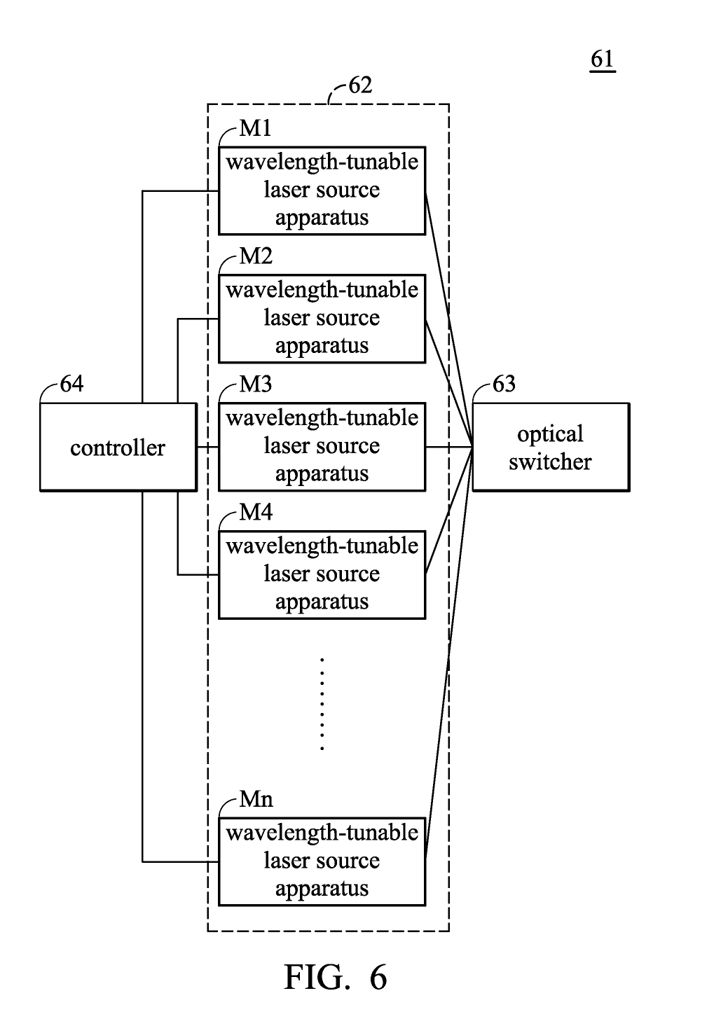

FIG. 6 depicts an embodiment of the laser system of the disclosure. As shown in FIG. 6, a laser system 61 includes a wavelength-tunable laser source array 62, an optical switcher 63 and a controller 64. The wavelength-tunable laser source array 62 outputs a plurality of the laser sources, wherein the laser sources have a central wavelength which is different from that of each other. The optical switcher 63 is coupled to the wavelength-tunable laser source array 62 for receiving the laser sources thereby selectively outputting one of the laser sources. The controller 64 is coupled to the wavelength-tunable laser source array 62 for controlling the wavelength mode.

The wavelength-tunable laser source array 62 includes n wavelength-tunable laser source apparatuses M1 to Mn. Each of the wavelength-tunable laser source apparatuses M1 to Mn can be the wavelength-tunable laser source apparatus 11. Each of the wavelength-tunable laser source apparatuses M1 to Mn has a central wavelength different from the other wavelength-tunable laser source apparatus such that the side mode suppression of the laser source output from the laser system 61 is optimum (i.e., larger than 45 dB). For example, if n is 3, then the central wavelength of the wavelength-tunable laser source apparatus M2 is 1545.6 nm. In other words, if the wavelength range of the wavelength-tunable laser source apparatus M2 with the optimum side mode suppression ration (i.e., lager than 45 dB) is 1545.6 nm±10 nm, then Fabry-Perot laser diodes with 1525.6 nm central wavelength and a 1565.6 nm central wavelength can be selected to serve as the wavelength-tunable laser source apparatus M1 and M3, respectively. Therefore, the wavelength range of the wavelength-tunable laser source apparatus M1 and M3 with the optimum side mode suppression ration (i.e., lager than 45 dB) is 1525.6 nm±10 nm and 1565.6 nm±10 nm, respectively, such that the range of the wavelength mode of the laser system 61 is tunable from 1515.6 nm to 1575.6 nm. In this range, the side mode suppression rations are all optimum values (i.e., lager than 45 dB). Because the wavelength mode of the laser sources can be tuned by the wavelength-tunable laser source apparatuses M1 to Mn, the laser system 61 using the wavelength-tunable laser source array 62 is also a wavelength-tunable laser system. The laser system 61 using the wavelength-tunable laser source array 62 has the advantage of overcoming the low power and low side mode suppression ration defects. In addition, the laser system 61 overcomes the restriction of the output modes of a single Fabry-Perot laser diode to increase the range of the tunable wavelength.

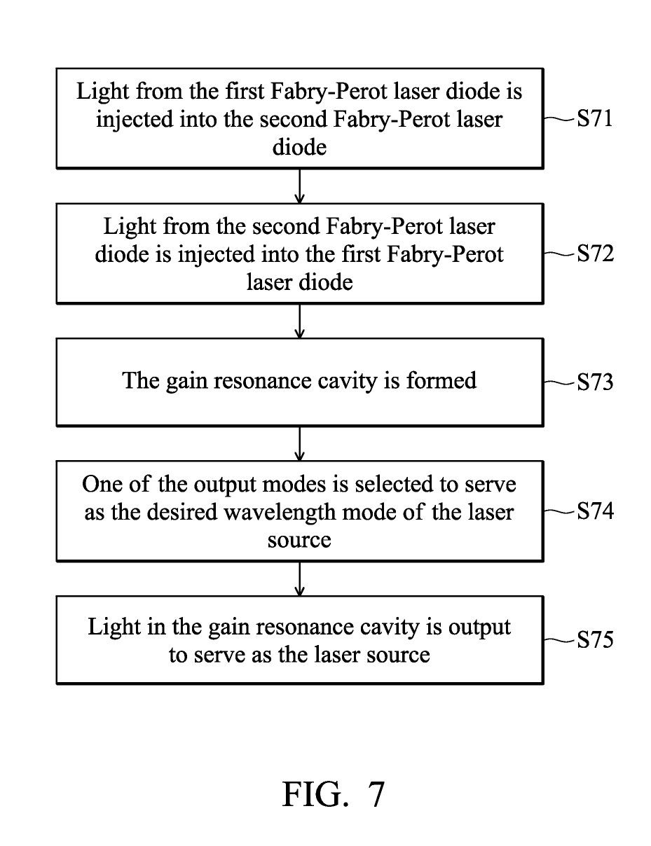

FIG. 7 is a sequence diagram of the method for adjusting a laser source wavelength. As shown in FIG. 7, the method for adjusting a laser source wavelength includes the following steps.

In step S71, light from the Fabry-Perot laser diode 12 is injected into the Fabry-Perot laser diode 13 by the optical coupler 15 and the tunable bandpass filter 14. In step S72, light from the Fabry-Perot laser diode 13 is injected into the Fabry-Perot laser diode 12 by the optical coupler 15 and the tunable bandpass filter 14. In step S73, the gain resonance cavity is formed with the Fabry-Perot laser diodes 12 and 13, the tunable bandpass filter 14 and the optical coupler 15. In step S74, one of the output modes is selected to serve as the desired wavelength mode of the laser source 17. In step S75, light in the gain resonance cavity is output to serve as the laser source 17.

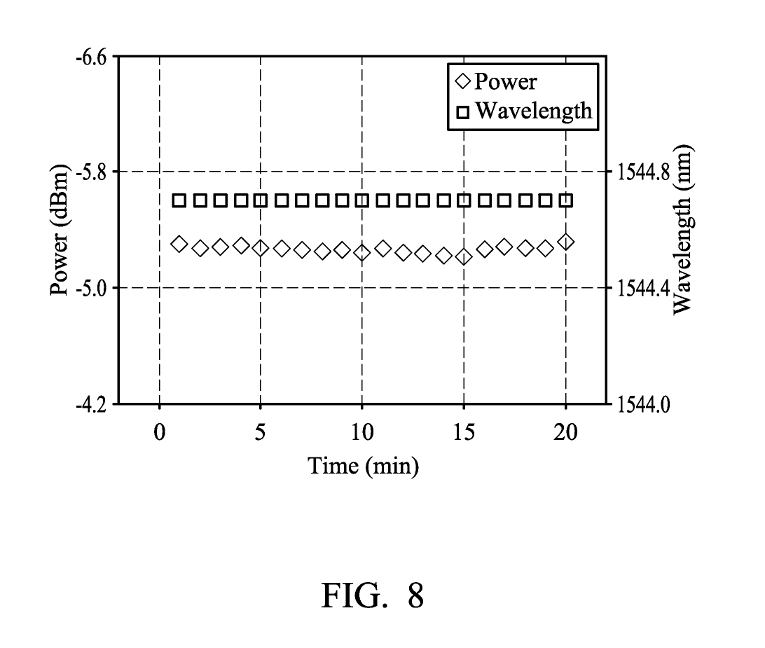

FIG. 8 shows the relationship between wavelength, power and timing of the wavelength-tunable laser source apparatus. As shown in FIG. 8, for 20 minutes, the wavelength mode of the laser source 17 is steadily maintained at 1544.7 nm, and the power of the laser source 17 is steadily maintained at −5.3 dBm, too. Therefore, the laser sources from the wavelength-tunable laser source apparatus 11 and the laser system 61 of the present disclosure are both operated with high stability.

In summary, the wavelength-tunable laser source apparatus 11 and the laser system 61 have a high side mode suppression ration and high power stability, and the Fabry-Perot laser diodes are cheaper. Therefore, the wavelength-tunable laser source apparatus 11 and the laser system 61 can be applied directly to serve as a light source in an optical fiber communication (i.e., wavelength division multiplexing, WDM or time-division multiplexing, TDM).

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wavelength-tunable laser source apparatus, comprising:
first and second Fabry-Perot laser diodes, wherein one of the first and second Fabry-Perot laser diodes outputs a light source to be injected into the other of the first and second Fabry-Perot laser diodes;
a tunable bandpass filter, coupled between the first and second Fabry-Perot laser diodes to adjust the light source to a desired wavelength mode; and
an optical coupler, coupling the light source,
wherein a gain resonance cavity is formed by the first and second Fabry-Perot laser diodes, the tunable bandpass filter and the optical coupler, and the optical coupler outputs light in the gain resonance cavity to serve as a laser source.

2. The wavelength-tunable laser source apparatus as claimed in claim 1, wherein the first and second Fabry-Perot laser diodes have a plurality of output modes and each two output mode has a fixed mode spacing.

3. The wavelength-tunable laser source apparatus as claimed in claim 2, wherein the tunable bandpass filter selects one of the output modes to serve as the desired wavelength mode of the laser source.

4. The wavelength-tunable laser source apparatus as claimed in claim 3, wherein a tuning step of the desired wavelength mode of the laser source is determined by the fixed mode spacing.

5. The wavelength-tunable laser source apparatus as claimed in claim 1, wherein the gain resonance cavity is an inter-injection resonance cavity.

6. The wavelength-tunable laser source apparatus as claimed in claim 1, wherein the optical coupler is a 50:50 optical coupler.

7. The wavelength-tunable laser source apparatus as claimed in claim 1, further comprising:
a polarization controller, controlling polarization states of the light source such that the light source is maintained in a steady state.

8. The wavelength-tunable laser source apparatus as claimed in claim 1, wherein a central wavelength of the first Fabry-Perot laser diode is the same as a central wavelength of the second Fabry-Perot laser diode.

9. A laser system, comprising:
a wavelength-tunable laser source array, comprising a plurality of wavelength-tunable laser source apparatuses to output a plurality of laser sources, wherein the laser sources have different central wavelengths and each of the wavelength-tunable laser source apparatus comprises:
first and second Fabry-Perot laser diodes, wherein one of the first and second Fabry-Perot laser diodes outputs a light source to be injected into the other of the first and second Fabry-Perot laser diodes;
a tunable bandpass filter, coupled between the first and second Fabry-Perot laser diodes to adjust the light source to a desired wavelength mode; and
an optical coupler, coupling the light source,
wherein a gain resonance cavity is formed by the first and second Fabry-Perot laser diodes, the tunable bandpass filter and the optical coupler, and the optical coupler outputs light in the gain resonance cavity to serve as a laser source;
an optical switcher, coupled to the wavelength-tunable laser source array to receive the laser source thereby selectively outputting one of the laser
a controller, coupled to the wavelength-tunable laser array to control a wavelength mode of the laser sources.

10. The laser system as claimed in claim 9, wherein the first and second Fabry-Perot laser diodes have a plurality of output modes and each two output mode has a fixed mode spacing.

11. The laser system as claimed in claim 10, wherein the tunable bandpass filter selects one of the output modes to serve as the desired wavelength mode of the laser source.

12. The laser system as claimed in claim 11, wherein a tuning step of the desired wavelength mode of the laser source is determined by the fixed mode spacing.

13. The laser system as claimed in claim 10, wherein each of the wavelength-tunable laser source apparatus further comprises a polarization controller, controlling polarization states of the light sources such that the light sources is maintained in a steady state.

14. The laser system as claimed in claim 10, wherein the laser system and the wavelength-tunable laser source apparatus are applied to optical fiber communication.

15. The laser system as claimed in claim 10, wherein the optical coupler is a 50:50 optical coupler.

16. The laser system as claimed in claim 10, wherein the central wavelength of the first Fabry-Perot laser diode is the same as the central wavelength of the second Fabry-Perot laser diode.

17. An method for adjusting a laser source wavelength, comprising
injecting light from a first Fabry-Perot laser diode into a second Fabry-Perot laser diode by an optical coupler and a tunable bandpass filter;
injecting light from the second Fabry-Perot laser diode into the first Fabry-Perot laser diode by the optical coupler and the tunable bandpass filter such that a gain resonance cavity is formed with the first and second Fabry-Perot laser diodes, the tunable bandpass filter and the optical coupler; and
outputting light in the gain resonance cavity to serve as a laser source.

18. The wavelength-tunable laser source apparatus as claimed in claim 17, wherein the first and second Fabry-Perot laser diodes have a plurality of output modes and each two output mode has a fixed mode spacing.

19. The wavelength-tunable laser source apparatus as claimed in claim 18, wherein the tunable bandpass filter selects one of the output modes to serve as the desired wavelength mode of the laser source.

20. The wavelength-tunable laser source apparatus as claimed in claim 19, wherein a tuning step of the desired wavelength mode of the laser source is determined by the fixed mode spacing.
